(19) United States
(12) Patent Application Publication
(10) Pub. No.: US 2012/0301579 A1
(43) Pub. Date: Nov. 29, 2012

(54) DRINK FLAVORING STRAW

(76) Inventors: Jeong-Min Lee, Seoul (KR); Seong-Jae Lee, Seoul (KR)

(21) Appl. No.: 13/517,342

(22) PCT Filed: Dec. 22, 2008
(86) PCT No.: PCT/KR2008/007580

§ 371 Date: Jun. 20, 2012

(30) Foreign Application Priority Data
Oct. 27, 2008 (KR) 10-2008-0106199
Nov. 3, 2008 (KR) 10-2008-0109148
Nov. 5, 2008 (KR) 10-2008-0110151
Nov. 10, 2008 (KR) 10-2008-0111922

(51) Int. Cl. A47G 21/18; A23L 2/56

(52) U.S. Cl. 426/85

(57) ABSTRACT

A drink flavoring straw which is characterized by containing dissimilar substance(s) formed in solid pellets which are soluble in the flow of drink, and the solution can be sucked up by the user leaving the pellets in a storage space formed in the straw, where they have been contained, and the said straw is characterized by being formed with one or more figure members on one or more parts.

### FIELD OF THE INVENTION

The present invention relates to a beverage straw which can add flavor to beverages by containing one or more flavor substances formed in pellets inside the straw.

In addition, the present invention relates to the technologies for producing beverage straws which can add flavor to beverages and is characterized by being formed with a character or characters, miniature or miniatures, Internet web site, or combination of letters and/of figures on one or more parts of the straw.

### BACKGROUND OF THE INVENTION

The object of the present invention is to improve the known art disclosed in U.S. Pat. No. 6,109,538, 6,333,050, 6,482,451, 5,156,335 and 5,989,590.

### SUMMARY OF THE INVENTION

### Technical Object

A related art disclosed in U.S. Pat. Nos. 6,109,538 and 6,333,050 provide filters at the top and bottom of the storage space of the flavor substance in the straw, so that the flavor substance is not discharged at once but melted slowly in the flow of the beverage. However, this kind of art has the disadvantage of flow resistance caused by the filter meanss.

U.S. Pat. No. 6,482,451 provides another related art, wherein the filter meanss are formed with additional closures and assembled and jointed onto the inner top and bottom of straw, which leads to rather excessive cost compared to the benefit and may deteriorate the appearance of the straw.

U.S. Design Pat. No. 487,375 describes an art wherein the top portion of straw is adhered and a part of side wall is formed with small holes to prevent the flavor substance from being discharged out before being dissolved. The disadvantage of this are is the complicated structure and manufacturing process, and the possibility of the flavor pellets clogging the small holes while sucking the beverage.

U.S. Design Pat. No. 487,375 further describes pressing the end of straw to retain the flavor substance. However, a straw is extruded in thin film, cut to desired length, and bored or formed with folded part by press or roller. Therefore, simple pressing of thin straw end leads to closing of the end by sucking pressure. To solve this problem, the straw wall must be formed thicker than normal straws.

In addition, the said related arts disclosed by U.S. Pat. Nos. 6,109,538, 6,333,050, 6,482,451, 5,156,335, and 5,989,590 are substantially limited to dissolving dissimilar substances in spherical shape and not closely related to the present invention which adds characters etc., to straws.

For information purpose, the related arts set forth and described hereinabove have been designed and implemented partially, for example, to add flavor, such as chocolate, banana, strawberry, etc., to milk at off-line to eliminate the flushing process of production facilities.

The present invention is to provide a technical variation of the said arts, which characters etc., are formed on one or more parts of straw to raise the value and to accomplish the object by forming filter means in a simple method.

### Technical Solution

For a means of the invention, the straw in compliance with the present invention can be produced by injection molding or extrusion molding, preferably by extrusion molding, in standard, stepped (two or three steps), or flexible form.

In addition, the said straw has ball-shape solids inside and formed with a filter means or a filter means where filter is formed inside, to retain the solid balls. The said filter is preferably separately produced or formed as an integral part of the straw, and as desired, on the opposite end of the straw from the filtered end, a lid or closure which can open and close the straw by rotation or swing can be formed.

In addition, the straw can be provided with adhesive tape for attaching to a paper carton, etc., or formed with a lid to enable attachment to the spout of beverage container, or formed with a cover which can be used as a cover for a cup or metal cap.

In addition, one opening (end) of the main body of the straw can be combined with a receptacle produced by extrusion molding, or the end and the receptacle form an integrated receptacle, and the shape of the said opening end can be formed by thermal molding or other process.

In addition, the said straw can be formed in an integrated body comprising the opening and filter part.

The above description provides substantial structure of the straw in compliance with the present invention, wherein the straw can be added with miniatures, characters, letters, figures, or any combination, on one or more parts of the straw spout or main body, where the characters, etc., can be formed with blow molding process or by assembling, whichever is preferable.

In addition, the inner space (storage space) of the said characters, etc., is filled with one or more ball-shaped, soluble dissimilar substances.

### Effect of the Present Invention

The straw in compliance with the present invention has enhanced appearance and can contain more dissimilar substances due to the character-shaped storage formed at a point of the straw.

### BRIEF DESCRIPTION OF THE DRAWINGS

FIGS. 1(a-i) show an exemplary embodiment of the present invention, where FIG. 1(a) shows the figure member assembled with top and bottom parts on the top and bottom sides,

FIG. 1(b) shows the figure member with storage space inside formed in the main body of the straw,

FIG. 1(c) shows the figure member formed in the top part of the main body of the straw,

FIG. 1(d) shows the figure member formed in integration with the filter part,

FIG. 1(e) shows the figure member formed in the bottom part of the main body of the straw,

FIG. 1(f) shows the figure member assembled with the main body of the straw by insertion,

FIG. 1(g) shows the lid-type figure member formed at the opening of the straw and can close and open the opening of the straw by moving up and down,

FIG. 1(h) shows the figure member formed in the top part of the main body of a corrugated straw,

FIG. 1(i) shows the figure member, or example, Internet website, form on the main body of the straw,

FIGS. 2(a-d) show another embodiment of the present invention, where FIG. 2(a) shows the figure member formed on a cap of beverage a container,

FIG. 2(b) shows a straw in compliance with the present invention applied to a cover of a cup,

FIG. 2(c) shows a straw in compliance with the present invention applied to a end part of a can,

FIG. 2(d) shows a straw in compliance with the present invention applied to a spout pouch container,

FIGS. 3(a-g) show various methods of configuring filter (filter means and filter formation part) in a straw, wherein FIG. 3(e) is an enlarged view of the cross section of the filter,

FIG. 3(f) is a view of filter formed at the top opening and another press-type filter formed at the bottom, of the straw,

FIG. 3(g) shows an exemplary use of the straw in compliance with the present invention,

FIGS. 4(a, b) show another embodiment of the present invention, where FIG. 4(a) shows the empty storage space of the straw before filled with pellet,

FIG. 4(b) shows the storage space filled with pellet.

FIGS. 5(a-d) show another embodiment of the present invention, where FIG. 5(a) shows the lid part formed on the straw to open and close the straw opening (closed state in the drawing) by moving up and down, wherein,

FIG. 5(b) shows opened state of the straw and lid shown in FIG. 5(a),

FIG. 5(c) shows the state of use,

FIG. 5(d) shows the lid part formed on a corrugated straw,

FIG. 6 is an enlarged view of the cross section of the concave part of the opening,

FIG. 7 is an enlarged cross section of an exemplary filter (filter means and filter formation part),

FIG. 8 shows another exemplary application of the filter,

FIG. 9 is the cross section of the concave part showing an exemplary filter configuration, and

FIG. 10 is an enlarged half-longitudinal cross section of straw showing still another exemplary embodiment of straw.

### DESCRIPTION OF THE PREFERRED EMBODIMENTS OF THE INVENTION

An exemplary embodiment of the present invention is described in detail referring to the attached drawings.

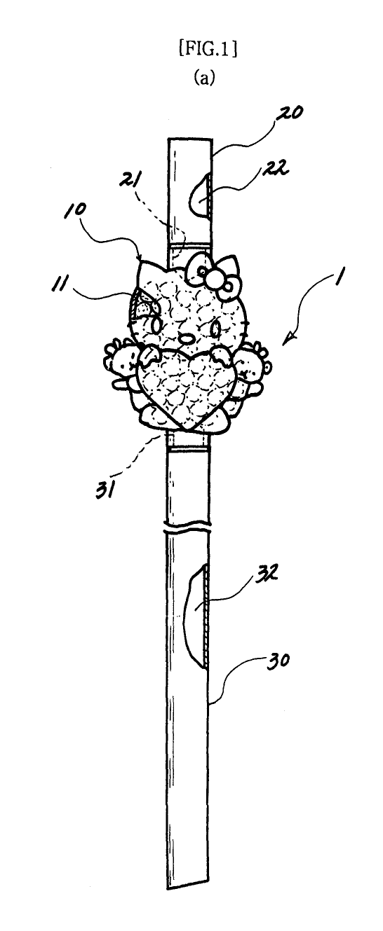

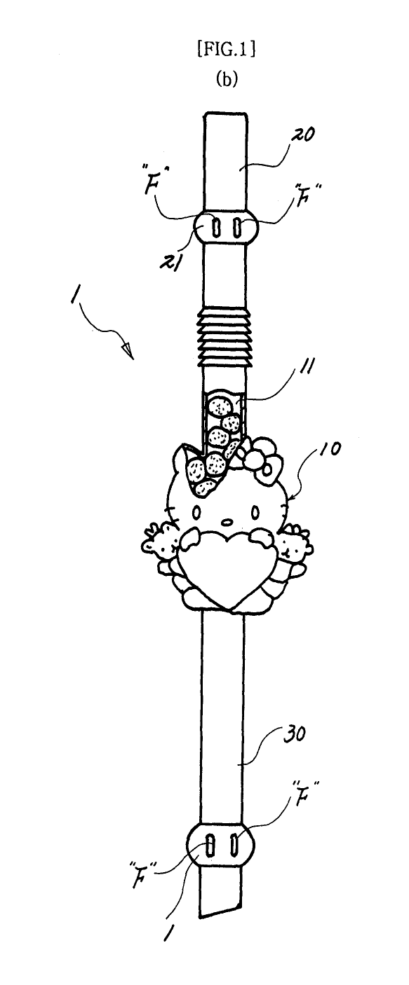

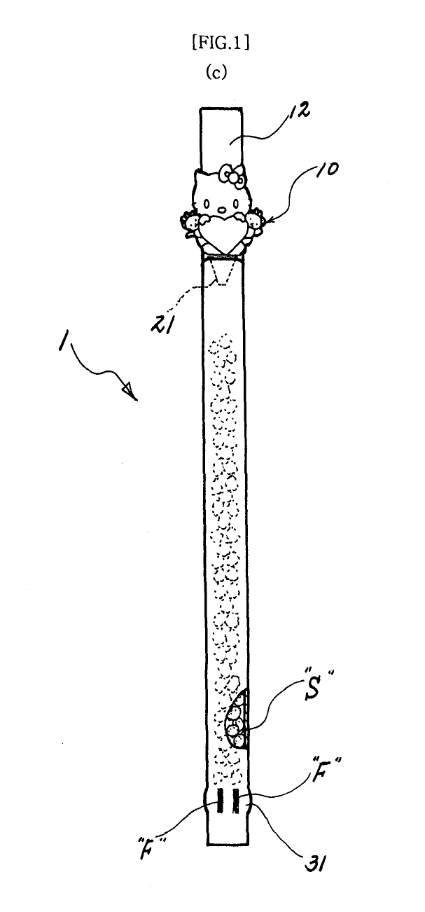

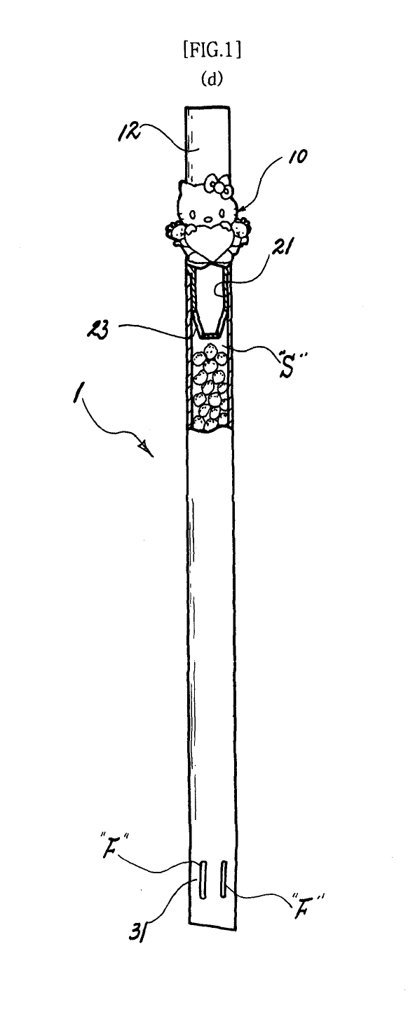

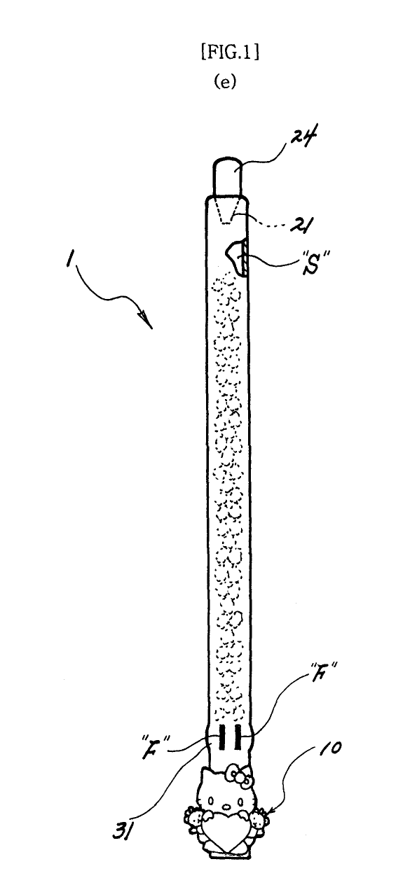

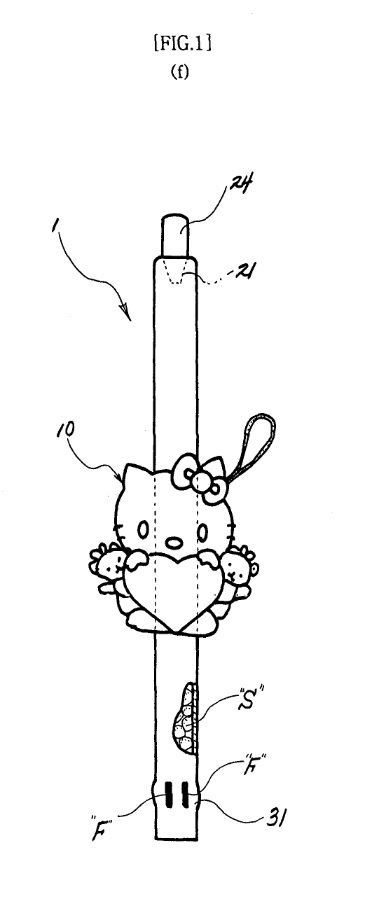

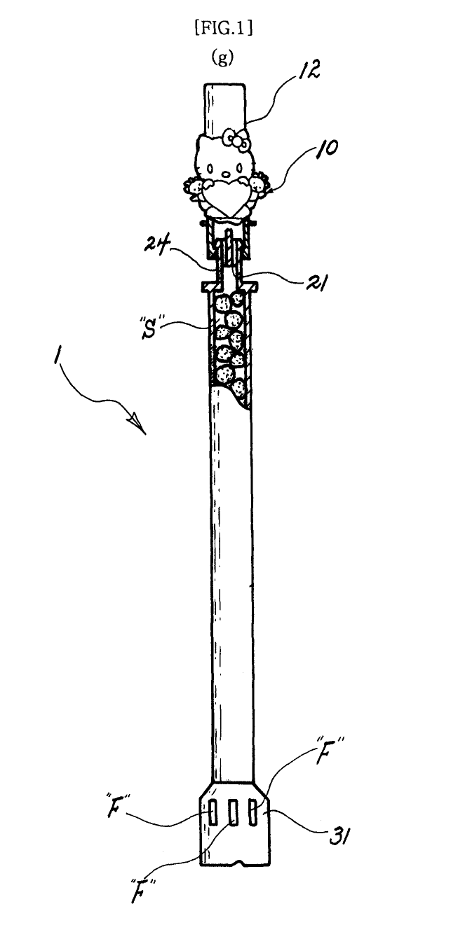

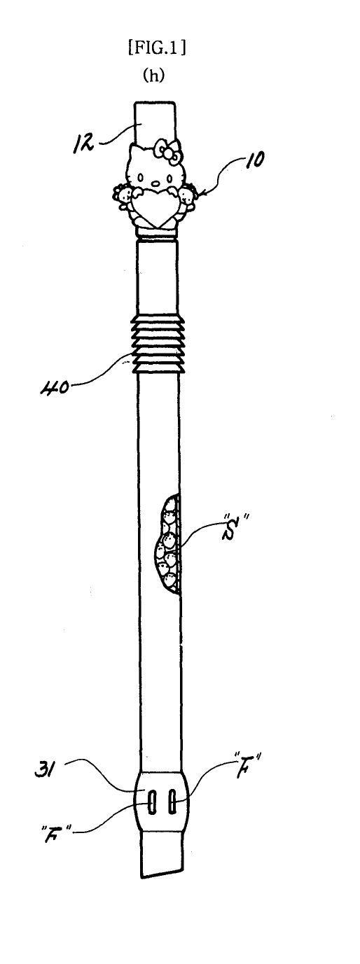

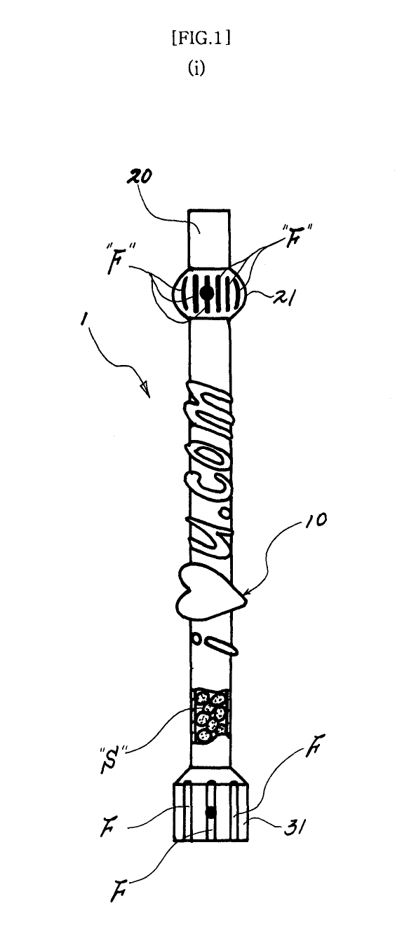

To describe an exemplary embodiment of the present invention referring to the attached drawings, as presented in FIG. 1, a figure member (10) formed with a storage space (11) is formed at a part of a straw (1), wherein the said figure member can be a character, a miniature or any other expression.

The said figure member (10) can be produced separately and assembled with the top member (20) and/or bottom member (30) (see FIG. 1(a)), and the filter (filter means, filter formation part) (21, 31) formed with multiple number of holes, on its top and bottom.

Dissimilar substances such as balls, pellets, or tablets containing flavor, aroma or nutrients which can be easily dissolvable in the flow of fluid are filled in the storage space (11) of the straw in compliance with the present invention.

The pellet in the storage space (11) can be spherical shape, such as pellets or tablets, and preferably, can afford the flow paths within them and can be dissolved in the fluid flow.

In addition, a filter formation part (31) formed with multiple number of holes is provided to retain the pellet in the storage space (11), or as desirable, said filter formation part (31) can be formed by roll processing (pressing) the bottom part of the storage space (11) into wave form, or can be placed at the lower part of the space (32) to extend the storage space (11).

In addition, the filter (21) formed above the said figure member (10) can also be assembled by insertion or hot pressed to form a wave-like filter.

In addition, the figure member (10) can be formed by heating a part of the straw (1), placing it in a mould, and applying pressure (this process can be replaced by a blow molding process comprising 1 stage and 2 stage.

When using the straw in compliance with the present invention, as illustrated in FIG. 1(a), the user would put the straw (1) into the container and suck the top opening (20). The pellet in the container flows into the storage space (11) through the space (32), dissolve the pellet in the storage space (11) and discharged from the top opening (20).

In another embodiment of the present invention illustrated in FIG. 1(b), the figure member (10) is formed at a point of the main body of the straw (1). Preferably, the figure member (10) is formed with a certain volume of storage space (11) by heating and pressing, or as desirable, when the straw (1) is molded, the figure member (10) can be formed in desired shape by pressing the straw (1) while it is still hot.

In still another embodiment of the present invention illustrated in FIG. 1(c), the straw (1) is formed with a storage space (S) inside the main body and a figure member (10) at its top, and a filter (21) above or below the figure member (10).

In addition, above the said figure member (10) is formed the end (12) of figure member for sucking up the beverage in the container, and the lower part of the straw (1) is formed a filter (31) and a filter formation part (F) if the filter (31) is to be formed with heat.

In another embodiment of the present invention illustrated in FIG. 1(d), a filter (21) provided with filter holes (23) is formed as an integrated part of the figure member (10), where, when the user sucks the end of the figure member (12), the fluid moves into the storage space (S) through the bottom filter (31), dissolves the pellet in the storage space (S) and exits through the filter (21).

In still another embodiment of the present invention illustrated in FIG. 1(e), the straw (1) is formed with a spout (24) for sucking at its upper part together with the filter (21), and a figure member (10) beneath the storage space (S), and a filter (21, 31) is provided above, beneath, or inside the said figure member (10).

In still another embodiment of the present invention illustrated in FIG. 1(f), the straw (1) is assembled with a figure member (10) on its exterior.

In still another embodiment of the present invention illustrated in FIG. 1(g), the straw (1) is assembled with a figure member (10), which can be closed and opened by moving up and down, at the spout (24). In FIG. 1(g), the figure member (10) is in open state.

In still another embodiment of the present invention illustrated in FIG. 1(h), the straw (1) formed with a corrugated part (40) is assembled with a figure member (10), which can be opened and closed by moving up and down, at the top.

In still another embodiment of the present invention illustrated in FIG. 1(i), the main body of the straw (1) is formed with letter, character, figure, or Internet web site, etc., on its exterior.

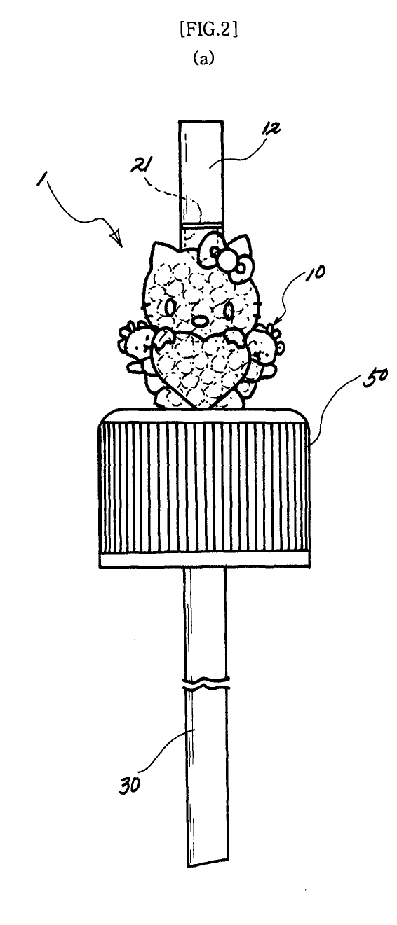

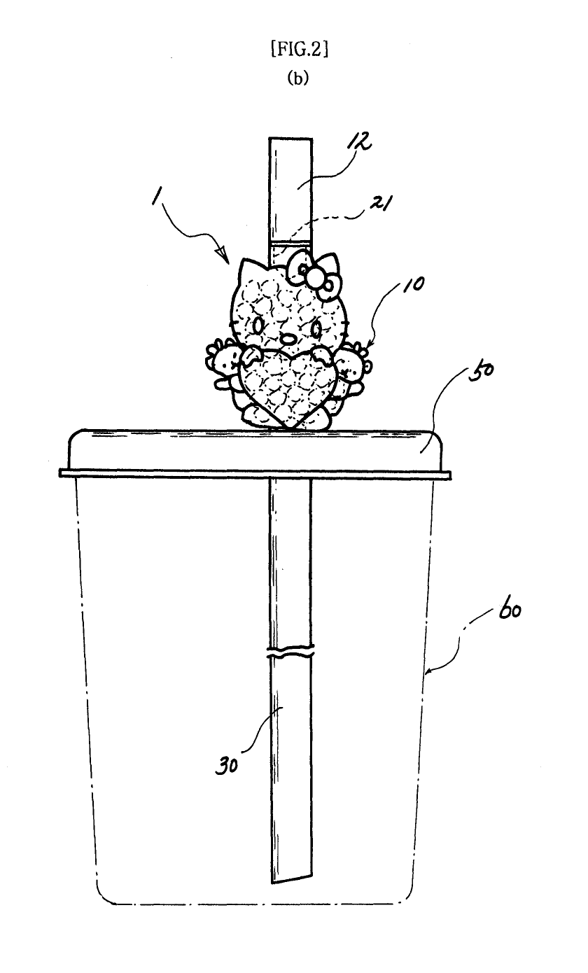

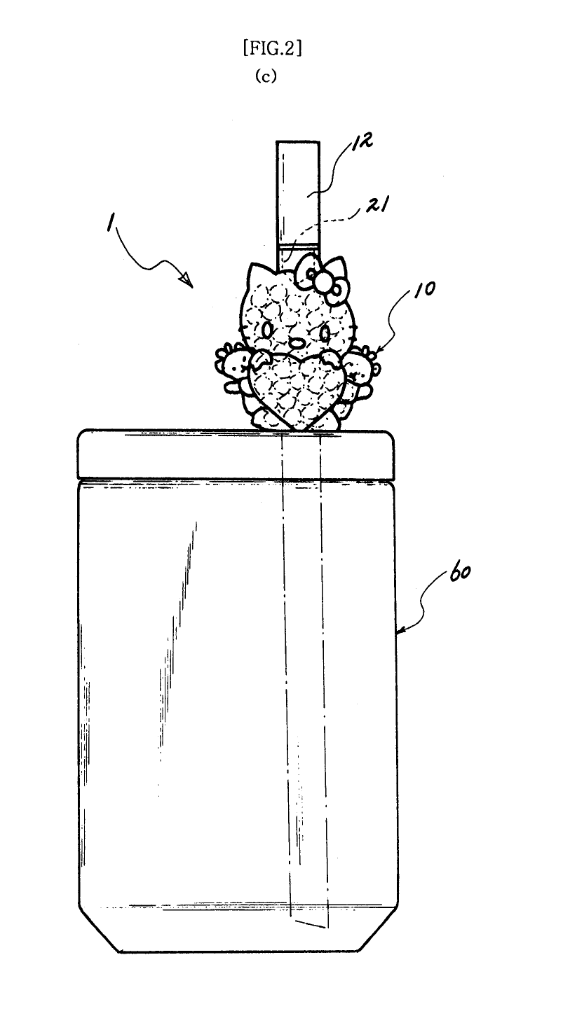

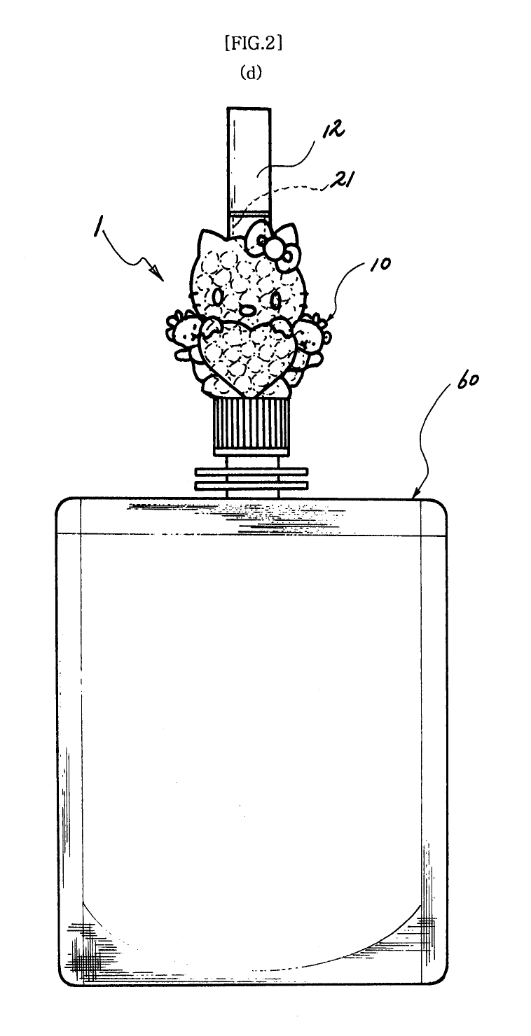

In still another embodiment of the present invention illustrated in FIG. 2(a), in order to combine the straw (1) formed with a figure member (10), such as a character, with the neck of a container, preferably, a cap member (50) is formed below the figure member (10). When using the straw (1), combine the cap member (50) of the straw (1) with the neck of the container and suck the end of the figure member (12). Then, the fluid moves into the storage space (S) through the bottom member (30), dissolves the pellet in the storage space (S) and exits through the filter (21) and the end of the figure member (12).

In addition, the bottom member (30) extending from the bottom of the said cap member (50) can be excluded or reduced in length, and in such case, the user will be able to drink the beverage with the container tilted to a side and not while it stands upright.

In still another embodiment of the present invention illustrated in FIG. 2(b), the straw (1) formed with a figure member (10), such as a character, can be combined with a container (60), such as a cup.

In still another embodiment of the present invention illustrated in FIG. 2(c), the straw (1) formed with a figure member (10), such as a character, can be combined with an end of a can or similar container.

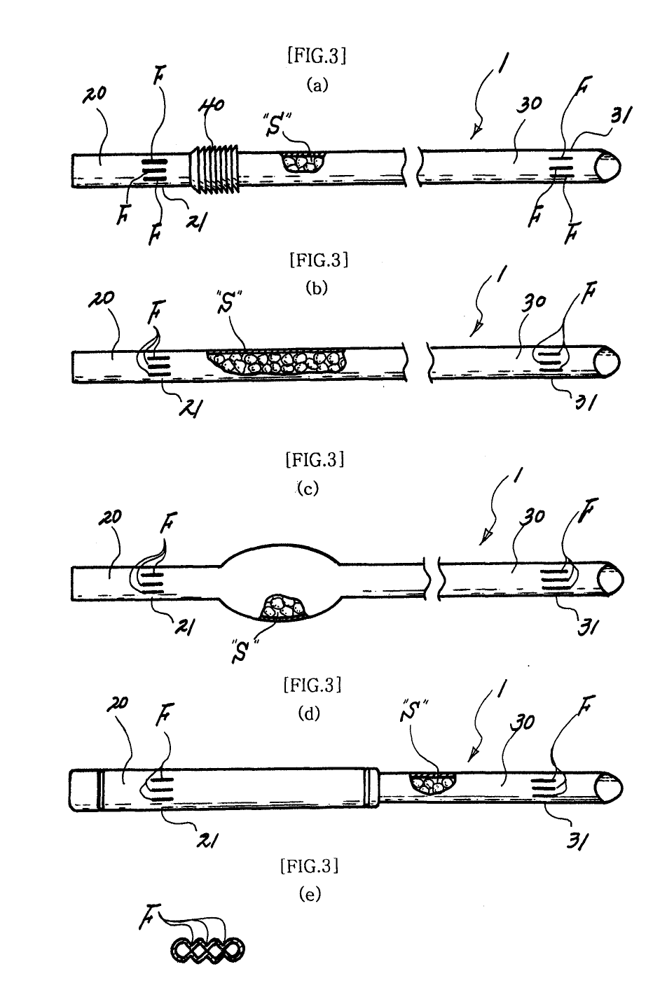

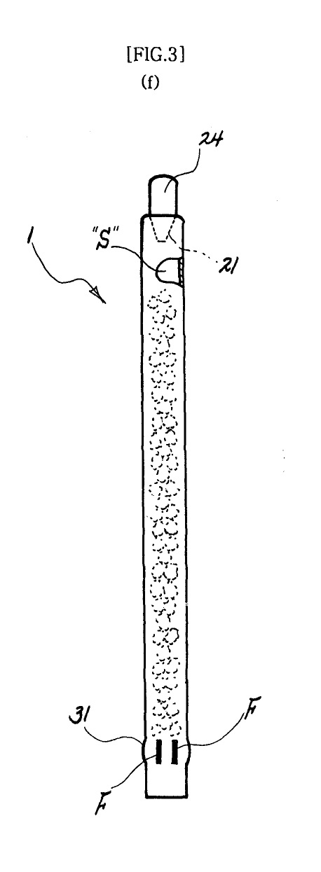

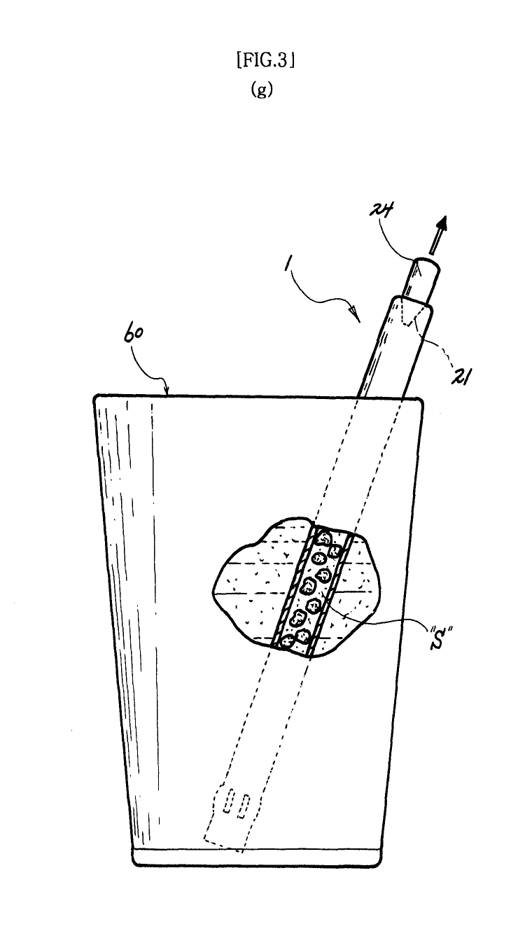

In still another embodiment of the present invention illustrated in FIG. 3(a-e), the straw (1) formed with a storage space (S) can be formed with a filter formation part (F) at its top (20) or bottom (30) part. Preferably, as illustrated in FIG. 3(e), to form a filter (21, 31), expand the objective part by heating and press it to form wave pattern, or as shown in the drawing, multiple number of filter formation parts (F) can be formed.

In still another embodiment of the present invention illustrated in FIG. 3(f), filter (21) is formed at the top centering the spout (24) and filter formation part (F) is formed by pressing. FIG. 3(g) shows an exemplary use of the straw (1).

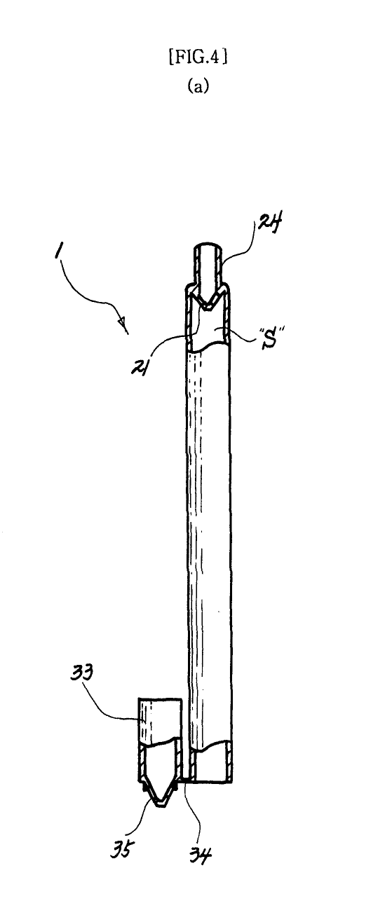

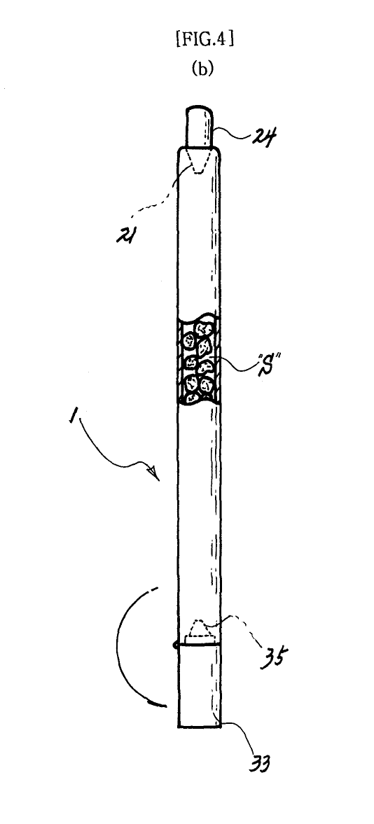

In still another embodiment of the present invention illustrated in FIG. 3(a, b), wherein FIG. 4(a) is the view before the storage space (S) of the straw (1) is filled with pellet. Here, a cap (33) is connected with a connector (34), and the cap (33) is preferably formed with a filter (35).

FIG. 4(b) shows the storage space filled with pellet (assembled state).

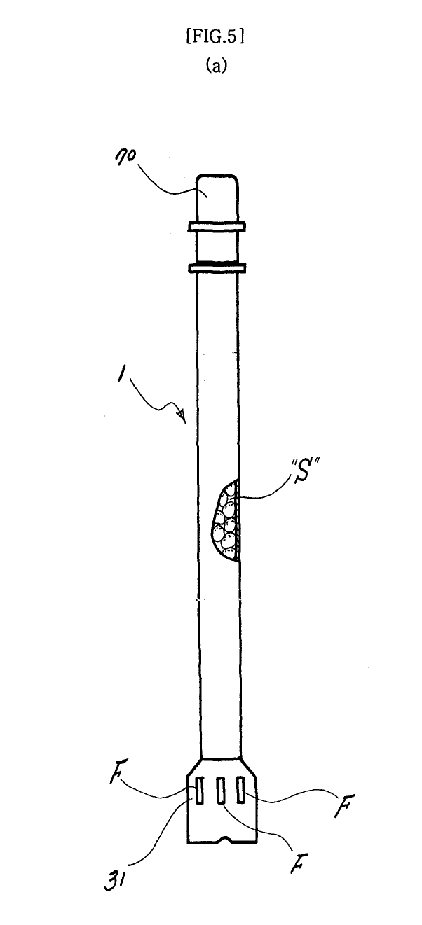

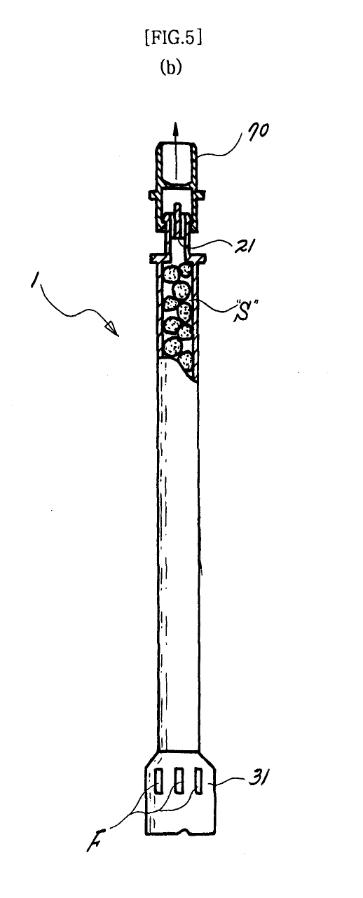

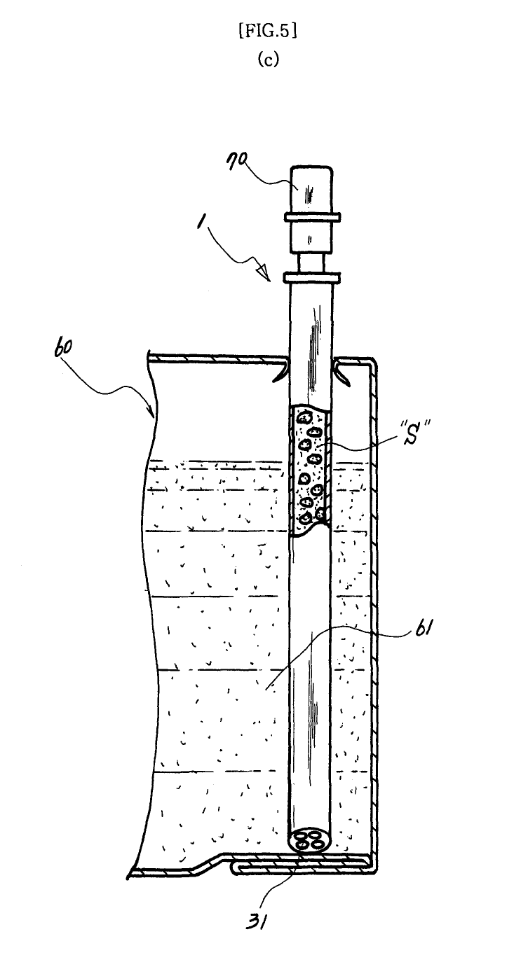

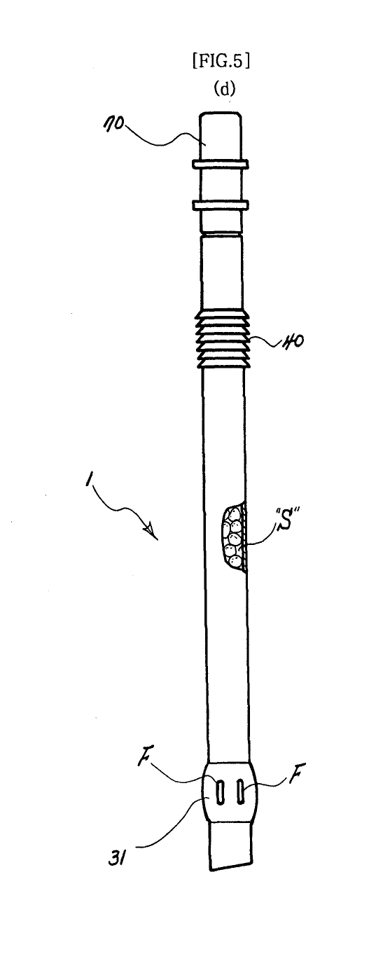

In still another embodiment of the present invention illustrated in FIG. 5(a-d), wherein FIG. 5(a) shows a straw (1) formed with a cap member (70) which can open or close the straw by lifting up or lowering down (closed state). FIG. 5(b) is a view of FIG. 5(a) where the cap member (70) is open. FIG. 5(c) is a view of in-use-state where the filter (31) is deformed.

As an exemplary variation, FIG. 5(d) is a view of the straw (1) which has a corrugated part (40) and formed with a cap member (70).

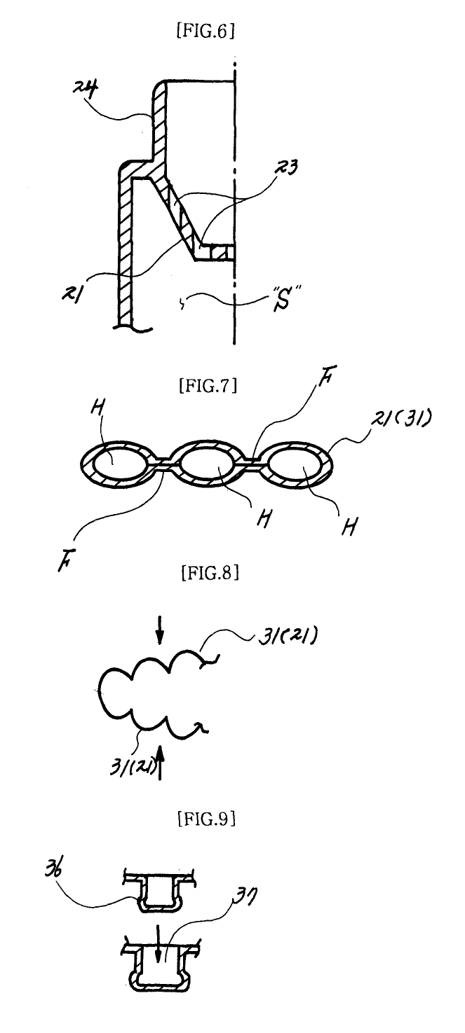

For another explanation, FIG. 6 is an enlarged cross section of the spout (24).

For still another explanation, FIG. 7 is a view of an enlarged cross section of the filter (21, 31) (filter means, filter formation part). In the drawing, filter holes (H) are formed in the filter formation part (F), thus, number of the filter holes (H) is proportional to the number of the filter formation part (F).

FIG. 8 shows another exemplary variation of the filter (21, 31), in an enlarged view.

FIG. 9 is an enlarged cross section of the concave part of an exemplary filter (21, 31). Here, the filer formation part (F) for filter holes (H) is replaced with concave and convex parts (36, 37).

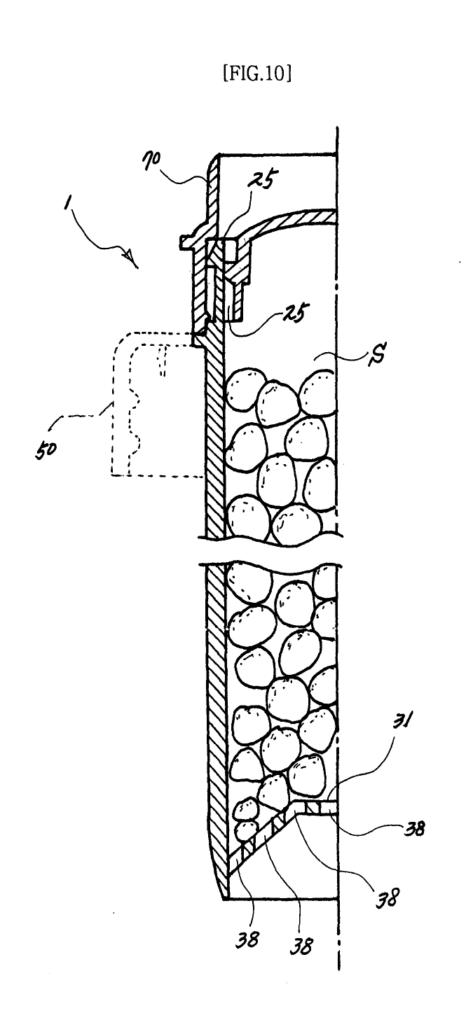

As another embodiment of the present invention, FIG. 10 is an enlarged, semi-longitudinal cross section of another variation of the straw (1) in compliance with the present invention, wherein the straw (1) having a cover member (70) is formed with a cap member (50).

### EFFECTS OF THE PRESENT INVENTION

The drink flavoring straw in compliance with the present invention is applicable for various drinks, including beverages, milk, alcoholic beverages, etc. Especially, when applied to milk, the user can drink the milk added with the flavor or aroma contained in the straw, which will promote the sales of milk.

What is claimed is:

1. A drink flavoring straw which is comprised of; a tubular body formed with one or more storage spaces which contain flavor and/or aroma ingredients formed in pellets, and; one or more filter means which hold the pellets and pass the drink only; and when the straw is sucked, the drink in a container enters the tubular body from the bottom opening, flow through the pellets in the storage space, dissolving the pellets, and exits through the upper opening, wherein the said straw is characterized by being formed with one or more figure members on one or more parts.

2. A drink flavoring straw in accordance with claim 1, wherein the said figure member is characterized by being a character or a miniature.

3. A drink flavoring straw in accordance with claim 1, wherein the said figure member is characterized by being an Internet website address or a combination of figures or letters.

4. A drink flavoring straw in accordance with claim 1, wherein the said storage space is filled with balls, pellets or tablets of flavoring substance(s) which are soluble in the carrier liquid (drink)

5. A drink flavoring straw in accordance with claim 1, wherein the said figure member is characterized by being formed with a storage space inside.

6. A drink flavoring straw in accordance with claim 1, wherein the said figure member is characterized by being an integral part of the main body of the straw.

7. A drink flavoring straw in accordance with claim 6, wherein the said figure member is characterized by being formed by applying heat to the main body of the straw and then air pressure.

8. A drink flavoring straw in accordance with claim 1, wherein the said filter means are formed above and below the figure member to keep the flavoring pellets within the storage space

9. A drink flavoring straw in accordance with claim 1, wherein the said figure member is characterized by being separately produced and assembled.

10. A drink flavoring straw in accordance with claim 1, wherein the said figure member is characterized by being formed at the top of the straw.

11. A drink flavoring straw in accordance with claim 1, wherein the said figure member is characterized by being formed at the bottom of the straw.

12. A drink flavoring straw in accordance with claim 10, wherein the said figure member is characterized by being assembled with the straw.

13. A drink flavoring straw in accordance with claim 11, wherein the said figure member is characterized by being assembled with the straw.

14. A drink flavoring straw in accordance with claim 1, wherein the said figure member is characterized by being formed with a lid for opening and closing at its top.

15. A drink flavoring straw in accordance with claim 14, wherein the said opening and closing lid is characterized by being opened when raised and closed when lowered.

16. A drink flavoring straw in accordance with claim 1, wherein the said filter means are formed at the top and bottom of the straw, and the filter means are processed to provide multiple number of filter holes.

17. A drink flavoring straw in accordance with claim 1, wherein the said straw with the said figure member is characterized by being formed with a cap member which can be assembled with a drink container.

18. A drink flavoring straw which is characterized by containing dissimilar substance(s) formed in solid pellets which are soluble in the flow of drink, and the solution can be sucked up by the user leaving the pellets in a storage space formed in the straw, where they have been contained, and the said straw is characterized by being formed with one or more figure members on one or more parts.

19. A drink flavoring straw in accordance with claim 18, wherein the said figure member is characterized by being a character or a miniature.

20. A drink flavoring straw in accordance with claim 18, wherein the said filter means is characterized by being formed with multiple number of filter holes by pressing or heating.

21. A drink flavoring straw which is characterized by containing dissimilar substance(s) formed in solid pellets which are soluble in the flow of drink, and the solution can be sucked up by the user leaving the pellets in a storage space formed in the straw, where they have been contained, and the said filter means is characterized by being formed with filter holes in wave form.

22. A drink flavoring straw in accordance with claim 21, wherein the said tubular body is characterized by being formed with an integral spout at the top.

23. A drink flavoring straw in accordance with claim 21, wherein the said tubular body is characterized by being formed with cap member which opens or close the filter holes by being lifted up or lowered down.

24. A drink flavoring straw which contains dissimilar substance(s) formed in solid pellets in a storage space, which are soluble in the flow of drink, and the solution can be sucked up by the user leaving the pellets in a storage space formed in the straw, where they have been contained, and the said filter means is characterized by being formed with filter holes in wave form.

25. A drink flavoring straw in accordance with claim 24, wherein the said filter means are formed by heating the pertinent part of the tubular body, expanding the part, and pressing to provide multiple number of filter holes.

26. A drink flavoring straw in accordance with claim 24, wherein the said filter means are applied with physical deformation to provide multiple number of filter holes.

27. A drink flavoring straw in accordance with claim 26, wherein the said filter holes are formed by pressing the filter formation part.
